(19) United States
(12) Patent Application Publication
(10) Pub. No.: US 2022/0331941 A1
(43) Pub. Date: Oct. 20, 2022

(54) ELECTRIC WORKING MACHINE

(71) Applicant: Koki Holdings Co., Ltd., Tokyo (JP)

(72) Inventors: Satoshi ABE, Ibaraki (JP); Shingo KOSUGI, Ibaraki (JP)

(21) Appl. No.: 17/618,299

(22) PCT Filed: May 29, 2020
(86) PCT No.: PCT/JP2020/021327

§ 371 Date: Dec. 10, 2021

(30) Foreign Application Priority Data
Jun. 13, 2019 (JP) 2019-110559

(51) Int. Cl. B25D 17/04; B25D 11/06

(52) U.S. Cl. CPC B25D 17/043; B25D 11/062; B25D 2211/061; B25D 2222/57; B25D 2250/121

(57) ABSTRACT

An electric working machine with the same or more prevention or suppression of the transmission of the vibration than that of a related art because of having the less components and the less man-hours for assemblies than those of the related art is achieved. A hammer drill includes a motor serving as a driving source and is equipped with a drill bit driven by a driving force that is output from the motor. The hammer drill includes a main-body housing and a handle housing forming at least a part of an outer shell, and the main-body housing and the handle housing are connected to each other through an elastic body to be relatively movable. The elastic body is formed on the main-body housing and the handle housing by a double-layer molding, and is a part of a continuous resin cover covering surfaces of the main-body housing and the handle housing.

### CROSS REFERENCE TO RELATED APPLICATIONS

This application is the U.S. National Phase under 35 U.S.C. § 371 of International Application No. PCT/JP2020/021327, filed on May 29, 2020, which claims the benefit of Japanese Application No. 2019-110559, filed on Jun. 13, 2019, the entire contents of which are hereby incorporated by reference.

### TECHNICAL FIELD

The present invention relates to an electric working machine, and, more particularly relates to an anti-vibration structure of the electric working machine.

### BACKGROUND ART

In these days, various electric working machines each using a motor as a driving source have been known. A rotational motion of an output shaft of the motor included in such an electric working machine is amplified or converted into a reciprocating motion, and then, is transmitted to a tip tool.

A Patent Document 1 describes a hammer drill that is one of the electric working machines as described above. The hammer drill described in the Patent Document 1 includes: a main body portion having a housing configured to house a motor, a transmission mechanism transmitting a driving force, that is output from the motor, to a tip tool, and others; and a handle portion configured to be gripped by an operator, and others. Further, an elastic body for use in preventing or suppressing the transmission of the vibration to the handle portion is arranged between the housing and the handle portion. The handle portion connected to the housing that houses the vibration source through the elastic body for use in preventing or suppressing the vibration transmission as descried above is called “anti-vibration handle” in some cases.

### RELATED ART DOCUMENT

### Patent Document

Patent Document 1: Japanese Patent Application Laid-Open Publication No. 2007-331072

### SUMMARY OF THE INVENTION

### Problems to be Solved by the Invention

In the hammer drill described in the Patent Document 1, the transmission of the vibration is prevented or suppressed by the elastic body that is arranged between the housing and the handle portion and that is a different body from the housing and the handle portion. Therefore, this manner leads to the more components, the more man-hours for assemblies, and besides, the complexed structure and the larger product size.

A purpose of the present invention is to achieve an electric working machine with the less man-hours for assemblies and the downsizing, and besides, with the same or more prevention or suppression of the transmission of the vibration than that of a related art because of having the less components and the simplified structure.

### Means for Solving the Problems

According to an aspect of the present invention, an electric working machine includes a first member and a second member forming at least apart of an outer shell, and the first member and the second member are connected to each other through the elastic body to be relatively movable. The elastic body is formed on the first member and the second member by a double-layer molding, and is a part of a continuous resin cover covering surfaces of the first member and the second member.

According to another aspect of the present invention, an electric working machine includes a first member and a second member forming at least a part of an outer shell, and the first member and the second member are connected to each other through the elastic body and a connecting portion. The connecting portion has a first end continuously connected to the first member, a second end continuously connected to the second member, and an intermediate portion connecting the first end and the second end. The first end, the second end and the intermediate portion are monolithically formed, and the intermediate portion is weaker than the first end and the second end. The elastic body is formed on the first member and the second member by a double-layer molding, and is a part of a continuous resin cover straddling the connecting portion and covering surfaces of the first member and the second member.

### Effects of the Invention

The present invention achieves an electric working machine with the less man-hours for assemblies and the downsizing, and besides, with the same or more prevention or suppression of the transmission of the vibration than that of a related art because of having the less components and the simplified structure.

### BRIEF DESCRIPTIONS OF THE DRAWINGS

FIG. 1 is a cross-sectional view of a hammer drill according to a first embodiment;

FIG. 2 is an enlarged cross-sectional view of an “A” portion surrounded by a dashed dotted line circle in FIG. 1;

FIG. 3 is another enlarged cross-sectional view of the “A” portion surrounded by the dashed dotted line circle in FIG. 1;

FIG. 4 is an explanatory diagram showing a step of forming a main-body housing and a handle housing;

FIG. 5 is an explanatory diagram showing a step of forming a resin cover;

FIG. 6 is a cross-sectional view of a hammer drill according to a second embodiment;

FIG. 7 is an enlarged cross-sectional view of a “B” portion surrounded by a dashed dotted line circle in FIG. 6;

FIG. 8 is another enlarged cross-sectional view of the “B” portion surrounded by the dashed dotted line circle in FIG. 6;

FIG. 9 is a cross-sectional view showing an example of an electric working machine to which the present application is applied;

FIG. 10 is a cross-sectional view showing another example of the electric working machine to which the present application is applied;

FIG. 11 is a partial cross-sectional view of a hammer drill according to a third embodiment;

FIG. 12A is an enlarged cross-sectional view of a “C” portion surrounded by a dashed dotted line circle in FIG. 11, FIG. 12B is an explanatory diagram showing an aspect of a breaking state of the intermediate portion, and FIG. 12C is an explanatory diagram showing another aspect of the breaking state of the intermediate portion;

FIG. 13 is an explanatory diagram showing one of modification examples of a connecting structure between the first member and the second member;

FIG. 14A is an explanatory diagram showing a cross section taken along a lien X-X in FIG. 13, and FIG. 14B is an explanatory diagram showing a cross section taken along a lien Y-Y in FIG. 13;

FIG. 15 is an explanatory diagram showing another one of the modification examples of the connecting structure between the first member and the second member; and

FIGS. 16A through 16D are each an explanatory diagram showing a modification example having a different connecting portion.

### BEST MODE FOR CARRYING OUT THE INVENTION

### First Embodiment

Hereinafter, one example of embodiments of the electric working machine of the present invention will be described in detail with reference to the accompanying drawings. In the following explanation, note that the same or substantially same configurations are denoted by the same reference symbols, and the repetitive description thereof will be appropriately omitted.

The electric working machine according to the present embodiment is a hammer drill having a plurality of switchable operational modes. The hammer drill according to the present embodiment has at least three operational modes that are a “drill mode”, a “hammer mode” and a “hammer drill mode”. In the drill mode, only a rotational force is applied to the tip tool. In the hammer mode, only a striking force is applied to the tip tool. On the other hand, in the hammer drill mode, both the rotational force and the striking force are applied to the tip tool.

As one example of the tip tool attached to the hammer drill, a drill bit is exemplified. The drill bit is used when, for example, a concrete, a stone or others is holed. Nevertheless, the tip tool attached to the hammer drill is not limited to the drill bit, and is selected from a plurality of tip tools in accordance with a workpiece, a type of a work for the workpiece or others.

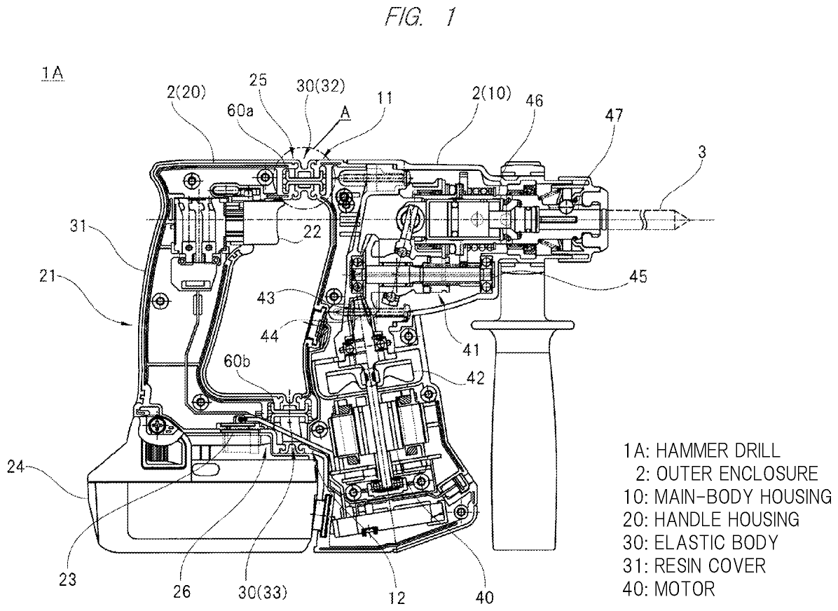

As shown in FIG. 1, a hammer drill 1A according to the present embodiment includes a main-body housing 10 serving as the first member and a handle housing 20 serving as the second member, and at least a part of an outer shell 2 of the hammer drill 1A is made of the main-body housing 10 and the handle housing 20. The main-body housing 10 and the handle housing 20 are connected to each other through an elastic body 30 to be relatively movable. A connecting structure between the main-body housing 10 and the handle housing 20 will be described in detail later.

The main-body housing 10 houses a motor 40 that is a driving source of the tip tool (that is a drill bit 3 in the present embodiment) and a transmission mechanism 41 transmitting a driving force output from the motor 40 to the drill bit 3. On the other hand, the handle housing 20 forms a handle 21 gripped by the operator.

A trigger lever 22 is arranged in an upper portion of the handle housing 20, and a battery attachment portion 23 is arranged in a lower portion of the handle housing 20. When the trigger lever 22 is pulled in a state of satisfaction of predetermined conditions, the electricity is supplied from a battery (battery pack 24) attached to the battery attachment portion 23 to the motor 40 to operate the motor 40. In other words, the driving force is output from the motor 40.

The motor 40 that is housed in the lower portion of the main-body housing 10 is a brushless motor, and includes a cooling fan 42 and a pinion gear 43 at its output shaft. The pinion gear 43 meshes with a bevel gear 44 that is an input portion of the transmission mechanism 41. The transmission mechanism 41 includes an intermediate shaft 45 extending in a direction crossing the output shaft, and the bevel gear 44 is fixed to an end of the intermediate shaft 45. On the intermediate shaft 45, a conversion mechanism that converts the rotational motion of the intermediate shaft 45 into the reciprocation motion is arranged. The conversion mechanism includes an inner wheel, an outer wheel, a rolling body and a joint bar, the inner wheel is fixed to the intermediate shaft 45, and the outer wheel is arranged in periphery of the inner wheel to surround the inner wheel. The rolling body intervenes between the inner wheel and the outer wheel, and the joint bar protrudes from an outer circumferential surface of the outer wheel toward outside of the outer wheel in a radial direction. Grooves that have arc cross sections and cross each other are formed on an outer circumferential surface of the inner wheel and an inner circumferential surface of the outer wheel. One part of the rolling body fits with the groove formed in the inner wheel while the other part fits with the groove formed in the outer wheel. In other words, the inner wheel and the outer wheel are connected to each other through the rolling body to be relatively rotatable.

Further, a clutch is arranged on the intermediate shaft 45, the clutch being switched between a fastening state in which the motive force is transmitted from the intermediate shaft 45 to the conversion mechanism and a free state in which the motive force is not transmitted from the intermediate shaft 45 to the conversion mechanism. The clutch is not relatively rotatable to the intermediate shaft 45, but movable forward and backward along the intermediate shaft 45. When the clutch moves backward to a predetermined position (gets close to the inner wheel), the intermediate shaft 45 and the inner wheel are connected to each other through the clutch, and the motive force is transmitted from the intermediate shaft 45 to the inner wheel. On the other hand, when the clutch moves forward to a predetermined position (gets away from the inner wheel), the connection between the intermediate shaft 45 and the inner wheel is released, and the transmission of the motive force from the intermediate shaft 45 to the inner wheel is cut.

The movement (switching) of the clutch as described above is achieved in accordance with a switching operation for the operational modes by the operator. When the clutch is in the fastening state, the inner wheel is rotated by rotation of the intermediate shaft 45. Then, the outer wheel rolls along the surface of the inner wheel, and the joint bar accordingly swings frontward and backward.

Above the intermediate shaft 45, a cylinder 46 is arranged in parallel to the intermediate shaft 45. A ring gear is arranged on an outer circumference of the cylinder 46, the ring gear being movable frontward and backward along the cylinder 46 to be switched between a joint state in which the rotation of the intermediate shaft 45 is transmitted to the cylinder 46 and an unjointed state in which the rotation of the intermediate shaft 45 is not transmitted to the cylinder 46. The ring gear is switched in accordance with a mode switching operation by the operator. Note that the ring gear switched into the unjointed state idly moves on the cylinder 46.

In the cylinder 46, a piston, a striker and an intermediate part are housed. The piston, the striker and the intermediate part are arranged on a line in this order from a back side to a front side, and an air chamber is arranged between the piston and the striker. A retainer sleeve 47 is arranged in the front side of the cylinder 46, and a back end of the retainer sleeve 47 is fixed to an end of the cylinder 46 not to be relatively rotatable. A foot portion of the drill bit 3 is inserted into the retainer sleeve 47, and the retainer sleeve 47 holds the inserted foot portion of the drill bit 3. Therefore, when the rotation of the intermediate shaft 45 is transmitted to the cylinder 46 by the switching of the ring gear into the joint state, the retainer sleeve 47 and the drill bit 3 that is held by the retainer sleeve 47 rotate.

The joint bar of the conversion mechanism is connected to a back surface of the piston to be rotatable. By the frontward and backward swinging of the joint bar, the piston reciprocates frontward and backward inside the cylinder 46, and a pressure of the air chamber changes. Then, the striker is driven by the change of the pressure of the air chamber, the intermediate part is struck by the striker, and the drill bit 3 is struck by the intermediate part.

In the present embodiment, when the drill mode is selected by the mode switching operation of the operator, the state of the clutch becomes the free state, and the state of the ring gear becomes the joint state. By the rotation of the intermediate shaft 45 in these states, the inner wheel of the conversion mechanism is not rotated while the cylinder 46 is rotated. Therefore, only the rotational force is applied to the drill bit 3 that is held by the retainer sleeve 47.

On the other hand, when the hammer mode is selected by the mode switching operation of the operator, the state of the clutch becomes the fastening state, and the state of the ring gear becomes the unjointed state. By the rotation of the intermediate shaft 45 in these states, the inner wheel of the conversion mechanism is rotated while the cylinder 46 is not rotated. Therefore, the piston reciprocates inside the stopping cylinder 46, and only the striking force is applied to the drill bit 3 that is held by the retainer sleeve 47.

And, when the hammer drill mode is selected by the mode switching operation of the operator, the state of the clutch becomes the fastening state, and the state of the ring gear becomes the joint state. By the rotation of the intermediate shaft 45 in these states, the inner wheel of the conversion mechanism is rotated while the cylinder 46 is also rotated. Therefore, the piston reciprocates inside the rotating cylinder 46, and both the rotational force and the striking force are applied to the drill bit 3 that is held by the retainer sleeve 47.

Next, the connecting structure between the main-body housing 10 and the handle housing 20 will be explained. As already described, the main-body housing 10 and the handle housing 20 are connected to each other through the elastic body 30. As shown in FIG. 1, the handle housing 20 has two ends, and each of the ends is connected to the main-body housing 10 through the elastic body 30. Specifically, the handle housing 20 has an upper end 25 positioned in vicinity of (above) the trigger lever 22, and a lower end 26 positioned in vicinity of (front of) the battery attachment portion 23. On the other hand, the main-body housing 10 has an upper joint 11 connected to the upper end 25 of the handle housing 20 and a lower joint 12 connected to the lower end 26 of the handle housing 20. Through the elastic body 30, the upper end 25 of the handle housing 20 and the upper joint 11 of the main-body housing 10 are connected to each other, and the lower end 26 of the handle housing 20 and the lower joint 12 of the main-body housing 10 are connected to each other. As a result, the main-body housing 10 and the handle housing 20 are relatively movable. In other words, the handle housing 20 is movable relative to the main-body housing 10 within a predetermined range.

As shown in FIG. 1, the elastic body 30 that connects the handle housing 20 to the main-body housing 10 to be relatively movable is formed on the main-body housing 10 and the handle housing 20 by a double-layer molding, and is a part of a continuous resin cover 31 covering the surfaces of the main-body housing 10 and the handle housing 20. In other words, the upper end 25 of the handle housing 20 is connected to the upper joint 11 of the main-body housing 10 through one part of the continuous resin cover 31, and the lower end 26 of the handle housing 20 is connected to the lower joint 12 of the main-body housing 10 through another part of the continuous resin cover 31.

As understood from FIG. 1, one part of the resin cover 31 intervening between the upper end 25 of the handle housing 20 and the upper joint 11 of the main-body housing 10 is one end of the resin cover 31. Another part of the resin cover 31 intervening between the lower end 26 of the handle housing 20 and the lower joint 12 of the main-body housing 10 is another end of the resin cover 31. In the following explanation, the one end of the resin cover 31 intervening between the upper end 25 of the handle housing 20 and the upper joint 11 of the main-body housing 10 is referred to as “upper end 32”, and another end of the resin cover 31 intervening between the lower end 26 of the handle housing 20 and the lower joint 12 of the main-body housing 10 is referred to as “lower end 33” in some cases.

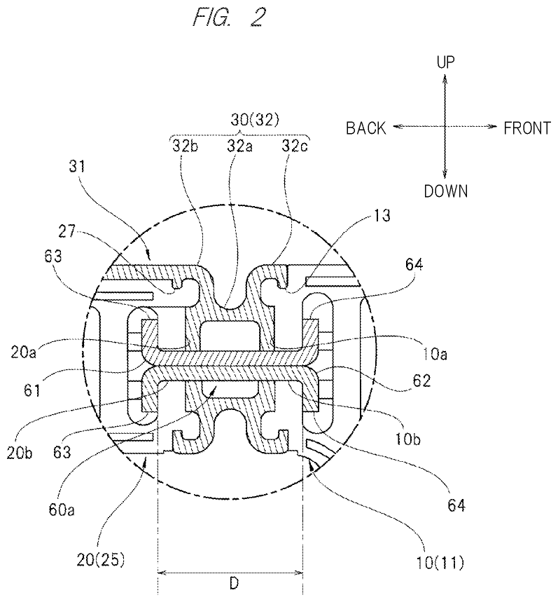

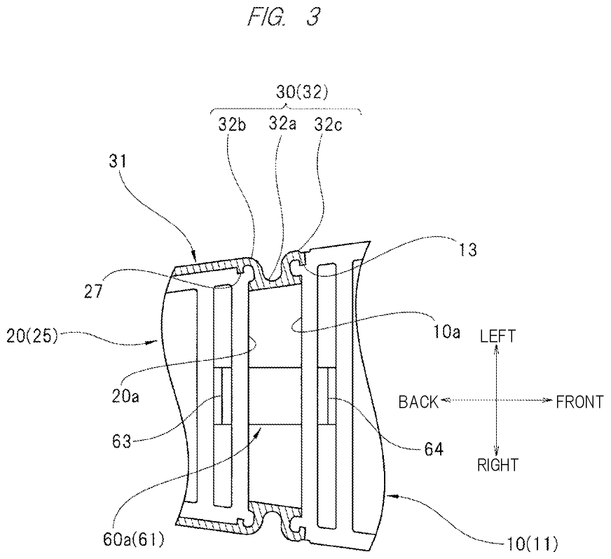

Next, details of the upper end 32 and the lower end 33 of the resin cover 31 will be explained. Nevertheless, the upper end 32 and the lower end 33 substantially have the same shape and structure. Therefore, by detail explanation for a shape and a structure of the upper end 32 with respect to FIGS. 2 and 3, a shape and a structure of the lower end 33 is also defined.

As shown in FIGS. 2 and 3, the upper end 32 includes an annular intervening portion 32a sandwiched between an end surface 20a of the handle housing 20 and an end surface 10a of the main-body housing 10 that face each other, a handle-housing side engaging portion 32b being closer to the handle housing 20 than the intervening portion 32a and engaging with an engaging portion 27 formed on the surface of the handle housing 20, and a main-body-housing side engaging portion 32c being closer to the main-body housing 10 than the intervening portion 32a and engaging with an engaging portion 13 formed on the surface of the main-body housing 10. In other words, the upper end 32 has the annular intervening portion 32a, the handle-housing side engaging portion 32b arranged on one side of the intervening portion 32a, and the main-body-housing side engaging portion 32c arranged on the other side of the intervening portion 32a. The handle-housing side engaging portion 32b expands from one side of the intervening portion 32a to outside of this intervening portion 32a in the radial direction, and then, is bent backward by substantially 90 degrees, and reaches the surface of the handle housing 20. The main-body-housing side engaging portion 32c expands from the other side of the intervening portion 32a to outside of this intervening portion 32a in the radial direction, and then, is bent forward by substantially 90 degrees, and reaches the surface of the main-body housing 10.

The upper end 25 of the handle housing 20 is moved relative to the main-body housing 10 by the elastic deformation of the upper end 32. More specifically, the upper end 25 of the handle housing 20 is moved relative to the main-body housing 10 by the elastic deformation of the intervening portion 32a causing the handle-housing side engaging portion 32b and the main-body-housing side engaging portion 32c to be close to or away from each other. In other words, the upper end 25 of the handle housing 20 is mainly movable forward and backward relative to the main-body housing 10.

As already described, the lower end 33 of the resin cover 31 shown in FIG. 1 substantially has the same shape and structure as those of the upper end 32 shown in FIGS. 2 and 3. Therefore, the lower end 26 of the handle housing 20 shown in FIG. 1 is moved relative to the main-body housing 10 by the elastic deformation of the lower end 33 of the resin cover 31 as similar to the upper end 32. In other words, the lower end 26 of the handle housing 20 is mainly movable forward and backward relative to the main-body housing 10 as similar to the upper end 25.

As described above, the handle housing 20 and the main-body housing 10 shown in FIG. 1 are connected to each other to be relatively movable through a part of the continuous resin cover 31 formed on these housings 20 and 10 by the double-layer molding. Therefore, the vibration occurring in the main-body housing 10 is prevented or suppressed from propagating to the handle housing 20 forming the handle 21. In other words, in the hammer drill 1A according to the present embodiment, a part of the resin cover 31 covering the surfaces of the handle housing 20 and the main-body housing 10 functions as an anti-vibration member. The resin cover 31, a part of which functions as the anti-vibration member, is a resin molding body formed on the handle housing 20 and the main-body housing 10 by the double-layer molding. Therefore, by the less components and the simpler structure than those of the related art, the less man-hours for assemblies and the downsizing can be achieved, and the same or more anti-vibration effect than that of the related art can be provided.

Note that a material of the resin cover 31 according to the present embodiment is elastomer. However, the material of the resin cover 31 is not particularly limited. Nevertheless, in a point of view of the prevention or the suppression of the transmission of the vibration, the resin cover 31 is preferably made of a material that is softer than materials of the handle housing 20 and the main-body housing 10.

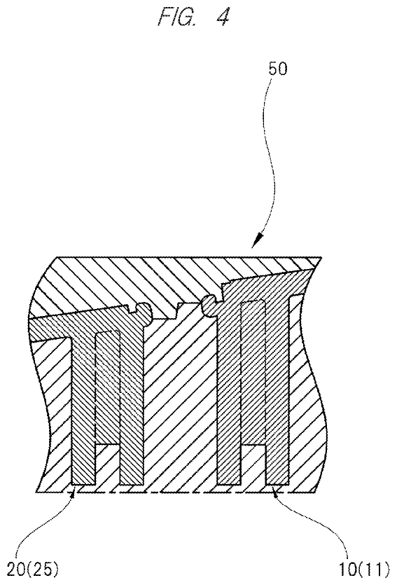

For example, the above-described resin cover 31 is formed as follows. As shown in FIG. 4, a material resin is fed into a mold 50 to simultaneously form the handle housing 20 and the main-body housing 10 (primary molding). Note that FIG. 4 shows only the upper end 25 of the handle housing 20 and the upper joint 11 of the main-body housing 10. However, practically, the handle housing 20 and the main-body housing 10 shown in FIG. 1 are entirely formed by the primary molding.

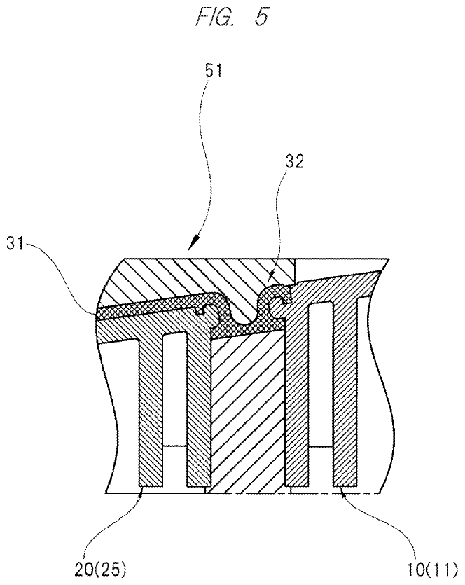

Then, as shown in FIG. 5, the formed handle housing 20 and main-body housing 10 are placed into a different mold 51, and then, a material resin (such as elastomer) is fed into the mold 51, in which the handle housing 20 and the main-body housing 10 are placed, to form the resin cover 31 on the handle housing 20 and the main-body housing 10 (secondary molding). In other words, by the double-layer molding (also often referred to as “two-color molding”), the resin cover 31 covering predetermined regions of the surfaces of the handle housing 20 and the main-body housing 10 and having the upper end 32 and the lower end 33 (FIG. 1) is formed. Note that FIG. 5 shows only the upper end 32 of the resin cover 31 and the vicinity of the upper end. However, practically, the entire resin cover 31 shown in FIG. 1 is formed by the secondary molding.

As shown in FIG. 1, a limitation member 60a intervenes between the upper end 25 of the handle housing 20 and the upper joint 11 of the main-body housing 10. Similarly, a limitation member 60b intervenes between the lower end 26 of the handle housing 20 and the lower joint 12 of the main-body housing 10. The handle housing 20 is connected to the main-body housing 10 through the elastic body 30 to be movable. Therefore, when a motion amount of the handle housing 20 relative to the main-body housing 10 is too large, a risk of breakage of the elastic body 30 arises. The limitation members 60a and 60b limit the motion amount of the handle housing 20 relative to the main-body housing 10 into a predetermined range to prevent the breakage of the elastic body 30.

In this case, the limitation members 60a and 60b shown in FIG. 1 substantially have the same shape and structure. Therefore, by detail explanation for a shape and a structure of the limitation member 60a intervening between the upper end 25 and the upper joint 11 with respect to FIGS. 2 and 3, a shape and a structure of the limitation member 60b intervening between the lower end 26 and the lower joint 12 is also defined.

As shown in FIGS. 2 and 3, the limitation member 60a is made of two metallic plates 61 and 62 each having both ends in a longitudinal direction bending by substantially 90 degrees. As shown in FIG. 2, the two metallic plates 61 and 62 straddle the upper end 25 and the upper joint 11 while overlapping back to back. Further, each bent portion 63 on one end of the metallic plates 61 and 62 in the longitudinal direction is inserted into the handle housing 20 through a slit 20b that is formed on the end surface 20a of the handle housing 20, and is locked with the periphery of the slit 20b. And, each bent portion 64 on the other end of the metallic plates 61 and 62 in the longitudinal direction is inserted into the main-body housing 10 through a slit 10b that is formed on the end surface 10a of the main-body housing 10, and is locked with the periphery of the slit 10b. In other words, each bent portion 63 on one end of the metallic plates 61 and 62 in the longitudinal direction functions as a stopper for pulling out of the upper end 25 of the handle housing 20, and each bent portion 64 on the other end of the metallic plates 61 and 62 in the longitudinal direction functions as a stopper for pulling out of the upper joint 11 of the main-body housing 10. As a result, the motion amount of the upper end 25 of the handle housing 20 relative to the main-body housing 10 is limited into a range of the entire length of the metallic plates 61 and 62. More strictly, the motion amount of the upper end 25 of the handle housing 20 is limited into a range of a distance (D) between the bent portion 63 on one end of the metallic plates 61 and 62 in the longitudinal direction and the bent portion 64 on the other end of the same in the longitudinal direction.

As already described, the limitation member 60b shown in FIG. 1 substantially has the same shape and structure as those of the limitation member 60a shown in FIGS. 2 and 3. Therefore, the motion amount of the lower end 26 of the handle housing 20 shown in FIG. 1 is also limited into the range of the entire length of the two metallic plates configuring the limitation member 60b.

Therefore, the motion amount of the handle housing 20 relative to the main-body housing 10 shown in FIG. 1 is limited into the range of the predetermined range (=the range of the distance (D) shown in FIG. 2). Further, an effect of limiting the unnecessary motion of the handle housing 20 is provided since the limitation members 60a and 60b made of the metallic plates are in contact with the handle housing 20 and the main-body housing 10 in a surficial manner. For example, an effect of limiting the excessive motion of the handle housing 20 relative to the main-body housing 10 in up and down directions and right and left direction is also provided.

### Second Embodiment

Next, another example of the embodiment of the electric working machine according to the present invention will be explained in detail with reference to the drawings. Nevertheless, the electric working machine according to the present invention is a hammer drill having the same basic structure as that of the hammer drill 1A (FIG. 1) according to the first embodiment. Accordingly, differences from the hammer drill 1A according to the first embodiment will be mainly explained, and explanation for the same or substantially same configuration will be appropriately omitted.

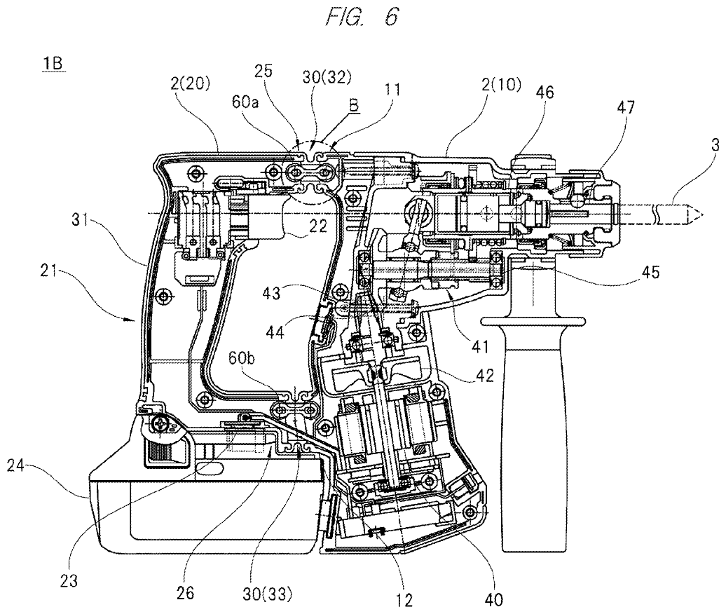

As shown in FIG. 6, a hammer drill 1B according to the present embodiment includes the main-body housing 10 serving as the first member and the handle housing 20 serving as the second member, and the main-body housing 10 and the handle housing 20 are connected to each other through the elastic body 30 to be relatively movable.

A connecting structure between the main-body housing 10 and the handle housing 20 shown in FIG. 6 is the same as the connecting structure between the main-body housing 10 and the handle housing 20 shown in FIG. 1. In other words, the main-body housing 10 and the handle housing 20 shown in FIG. 6 are connected to each other to be relatively movable through a part (upper end 32, lower end 33) of the continuous resin cover 31 formed on the main-body housing 10 and the handle housing 20 by the double-layer molding.

In comparison between FIGS. 1 and 6, limitation members 60a and 60b included in the hammer drill 1B according to the present embodiment are different from the limitation members 60a and 60b included in the hammer drill 1A according to the first embodiment. Accordingly, the limitation members 60a and 60b included in the hammer drill 1B according to the present embodiment will be explained in detail.

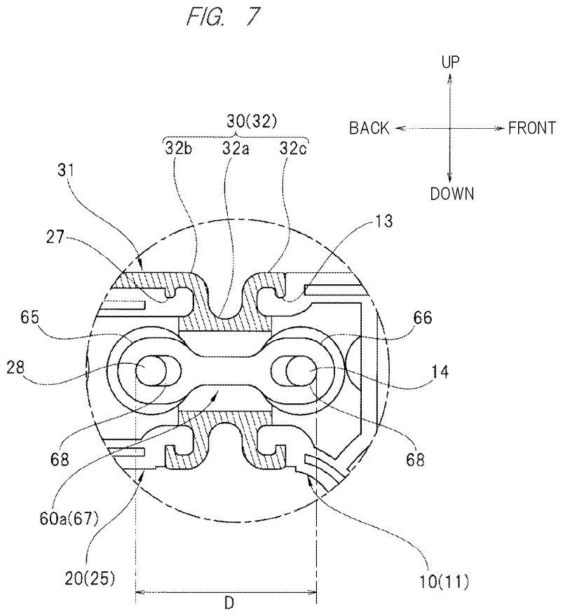

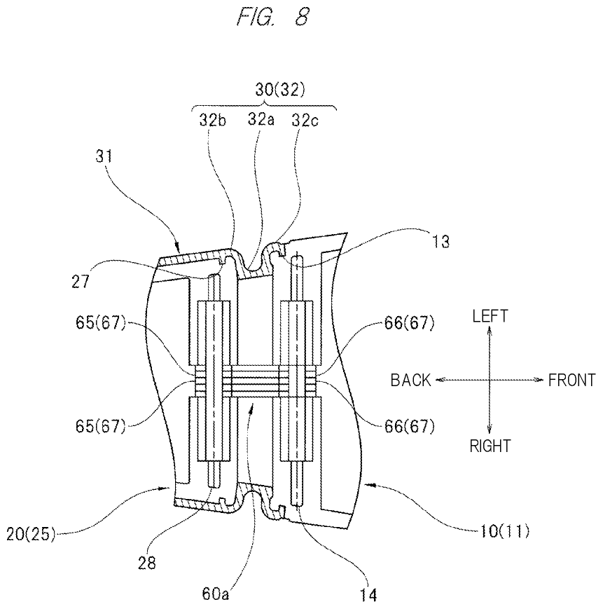

Nevertheless, the limitation members 60a and 60b shown in FIG. 6 substantially have the same shape and structure. Therefore, by detail explanation for a shape and a structure of the limitation member 60a with respect to FIGS. 7 and 8, a shape and a structure of the limitation member 60b is also defined.

As shown in FIGS. 7 and 8, the limitation member 60a is made of a plurality of metallic plates 67 each having both ends with large radial portions 65 and 66 in a longitudinal direction. The metallic plates 67 have the same shape and dimension as one another, and straddle the upper end 25 and the upper joint 11 while overlapping one another.

As shown in FIG. 7, a long hole 68 is formed in each of the large radial portions 65 and 66 of the metallic plates 67. The plurality of metallic plates 67 overlap one another so that the long holes 68 formed on the large radial portions 65 communicate to one another while the long holes 68 formed on the large radial portions 66 communicate to one another.

As shown in FIG. 8, a joint pin 28 protruding the long holes 68 (FIG. 7) formed on the large radial portions 65 of the metallic plates 67 is arranged in the upper end 25 of the handle housing 20, and both ends of this joint pin 28 engage with the handle housing 20. On the other hand, a joint pin 14 protruding the long holes 68 (FIG. 7) formed on the large radial portions 66 of the metallic plates 67 is arranged in the upper joint 11 of the main-body housing 10, and both ends of this joint pin 14 engage with the main-body housing 10. As a result, the motion amount of the upper end 25 of the handle housing 20 relative to the main-body housing 10 is limited into the range of the distance (D) shown in FIG. 7. In other words, the motion amount of the upper end 25 of the handle housing 20 relative to the main-body housing 10 is limited into a range of a distance (D) between the two long holes 68 formed on the both ends of the metallic plate 67 in the longitudinal direction.

As already described, the limitation member 60b shown in FIG. 6 substantially has the same shape and structure as those of the limitation member 60a shown in FIGS. 7 and 8. Therefore, the motion amount of the lower end 26 of the handle housing 20 shown in FIG. 6 is also limited into the range of the distance between the two long holes formed on both ends of the metallic plate in the longitudinal direction, the metallic plate configuring the limitation member 60b.

In other words, the motion amount of the handle housing 20 relative to the main-body housing 10 as shown in FIG. 6 is limited into the predetermined range (=the range of the distance (D) shown in FIG. 7).

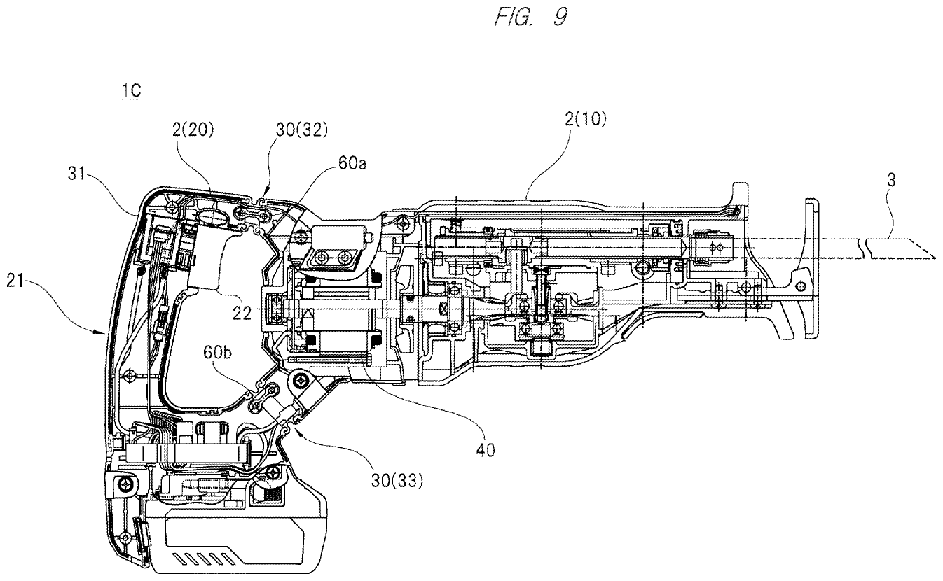

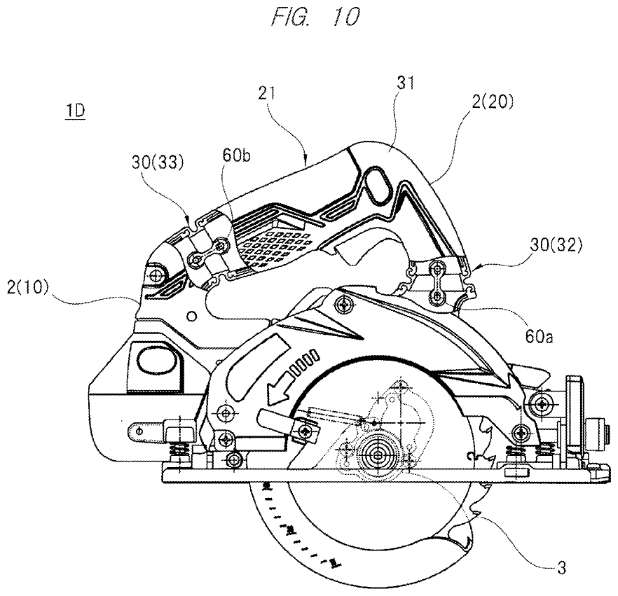

FIGS. 9 and 10 show different examples of the electric working machine including the main-body housing 10 and the handle housing 20 that are connected by the substantially same connecting structure as that of the hammer drill 1B according to the present embodiment. The electric working machine shown in FIG. 9 is a saber saw (also often called reciprocating saw). The electric working machine shown in FIG. 10 is a round saw.

A saber saw 1C shown in FIG. 9 includes a motor 40 serving as a driving source, and is equipped with a tip tool (saw blade 3) that is reciprocated by a driving force output from the motor 40. A round saw 1D shown in FIG. 10 includes a motor (not illustrated) serving as a driving source, and is equipped with a tip tool (saw blade 3) that is rotated by a driving force output from the motor.

Each of the saber saw 1C shown in FIG. 9 and the round saw 1D shown in FIG. 10 includes the main-body housing 10 and the handle housing 20 forming the outer shell 2. The main-body housing 10 and the handle housing 20 are connected to each other through the elastic body 30 to be relatively movable. Explanation for details of the connecting structure between the main-body housing 10 and the handle housing 20 will be omitted. However, the elastic body 30 is formed on the main-body housing 10 and the handle housing 20 by the double-layer molding, and is a part of the resin cover 31 covering surfaces of these housings 10 and 20.

The limitation members 60a and 60b limiting the motion amount of the handle housing 20 relative to the main-body housing 10 into a predetermined range are arranged in the connecting portion between the main-body housing 10 and the handle housing 20.

### Third Embodiment

Still another example of the embodiment of the electric working machine according to the present invention will be explained in detail with reference to the drawings. Nevertheless, the electric working machine according to the present invention is a hammer drill having the same basic structure as that of the hammer drill 1A according to the first embodiment (FIG. 1). Accordingly, differences from the hammer drill 1A according to the first embodiment will be mainly explained, and the explanation for the same or substantially same configuration will be appropriately omitted.

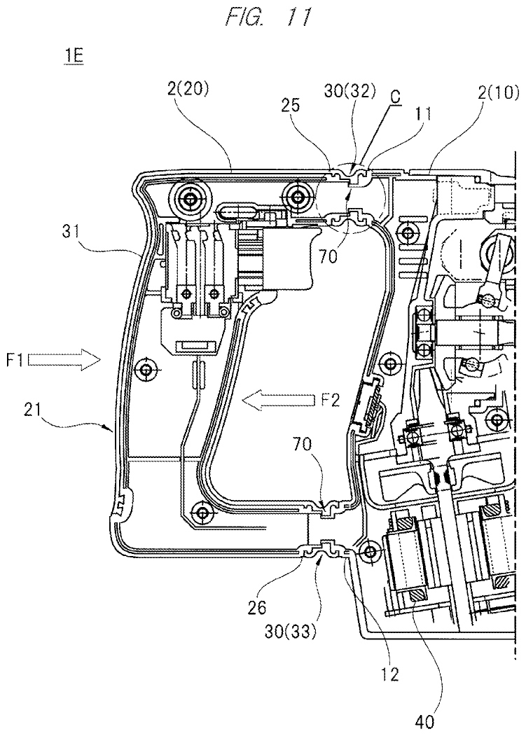

FIG. 11 is a partial cross-sectional view of a hammer drill 1E according to the present embodiment. The hammer drill 1E according to the present embodiment and the hammer drill 1A according to the first embodiment are in common in that the main-body housing 10 and the handle housing 20 forming the outer shell 2 are connected to each other through the elastic body 30. Further, the hammer drill 1E according to the present embodiment and the hammer drill 1A according to the first embodiment are also in common in that the elastic body 30 connecting the main-body housing 10 and the handle housing 20 is formed on the housings 10 and 20 by the double-layer molding and is a part (upper end 32, lower end 33) of the resin cover 31 covering the surfaces of these housings 10 and 20.

On the other hand, the hammer drill 1E according to the present embodiment is different from the hammer drill 1A according to the first embodiment in that the main-body housing 10 and the handle housing 20 are connected to each other through a connecting portion 70. In other words, the main-body housing 10 and the handle housing 20 in the hammer drill 1E according to the present embodiment are connected to each other through both the elastic body 30 and the connecting portion 70.

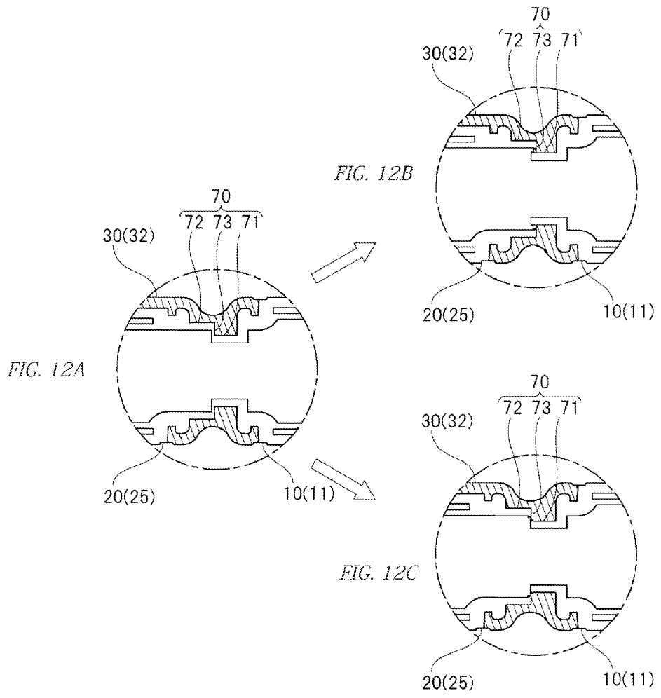

FIG. 12A is an enlarged view of a “C” portion surrounded with a dashed dotted line circle in FIG. 11. In other words, this is an enlarged view of a connecting portion between the upper end 25 of the handle housing 20 and the upper joint 11 of the main-body housing 10. As shown in FIG. 12A, the connecting portion 70 intervening between the upper end 25 of the handle housing 20 and the upper joint 11 of the main-body housing 10 includes a first end 71 continuously connected to the main-body housing 10, a second end 72 continuously connected to the handle housing 20, and an intermediate portion 73 connecting the first end 71 and the second end 72.

While the first end 71, the second end 72 and the intermediate portion 73 are formed to be monolithic, a thickness of the intermediate portion 73 is smaller than each thickness of the first end 71 and the second end 72. In other words, the first end 71 extending from the main-body housing 10 toward the handle housing 20 and the second end 72 extending from the handle housing 20 toward the main-body housing 10 are connected to each other through the thinner intermediate portion 73.

The thinner intermediate portion 73 than the first end 71 and the second end 72 is a weaker portion in strength than both the first end 71 and the second end 72. In other words, the upper end 25 of the handle housing 20 is connected to the upper joint 11 of the main-body housing 10 through the elastic body 30 and the connecting portion 70 including the weaker portion. Note that the connecting portion 70 intervening between the lower end 26 of the handle housing 20 and the lower joint 12 of the main-body housing 10 as shown in FIG. 11 has the same shape and structure as those of the connecting portion 70 shown in FIG. 12A. In other words, as similar to the upper end 25, the lower end 26 of the handle housing 20 is connected to the lower joint 12 of the main-body housing 10 through the elastic body 30 and the connecting portion 70 including the weaker portion.

The connecting portion 70 is broken by application of a predetermined force (F1) or more to the handle housing 20, the force acting in a direction of bringing the handle housing 20 to be close to the main-body housing 10, or by application of a predetermined force (F2) or more thereto, the force acting in a direction of bringing the handle housing 20 to be away from the main-body housing 10 as shown in FIG. 11. Specifically, by the application of the force (F1) to the handle housing 20, the intermediate portion 73 that is the weaker portion of the connecting portion 70 is broken as shown in FIG. 12B. On the other hand, by the application of the force (F2) to the handle housing 20, the intermediate portion 73 that is the weaker portion of the connecting portion 70 is broken as shown in FIG. 12C.

In this case, as shown in FIG. 11, the elastic body 30 that is a part of the continuous resin cover 31 covering the surfaces of the handle housing 20 and the main-body housing 10 straddles the connecting portion 70 to cover the surfaces of the handle housing 20 and the main-body housing 10. Therefore, the elastic body 30 is temporarily compressed when the intermediate portion 73 is broken as shown in FIG. 12B by the application of the force (F1) to the handle housing 20. On the other hand, the elastic body 30 is temporarily elongated when the intermediate portion 73 is broken as shown in FIG. 12C by the application of the force (F2) to the handle housing 20.

After the intermediate portions 73 (FIGS. 12A though 12C) included in the two connecting portions 70 shown in FIG. 11 are broken as described above, the handle housing 20 and the main-body housing 10 are connected to each other through only the elastic body 30. In other words, the handle housing 20 and the main-body housing 10 are connected to each other to be relatively movable. As a result, the handle housing 20 is movable frontward and backward relative to the main-body housing 10, and the vibration occurring in the main-body housing 10 is prevented or suppressed from propagating to the handle housing 20 forming the handle 21.

Note that the intermediate portion 73 may be broken in a factory before shipment of the hammer drill 1E, or may be broken after purchase by a user who bought the hammer drill 1E.

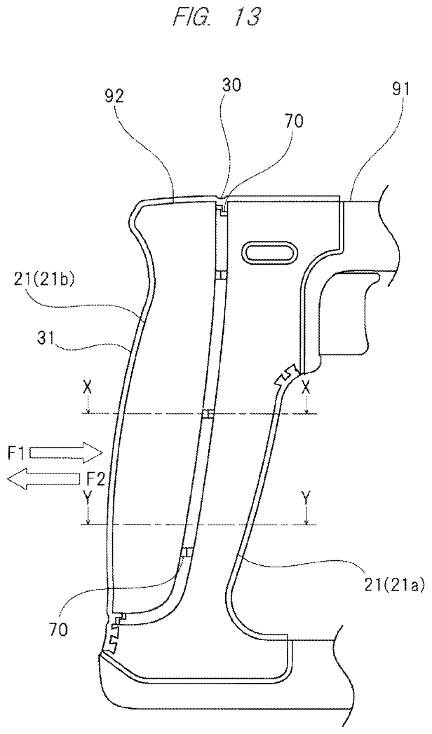

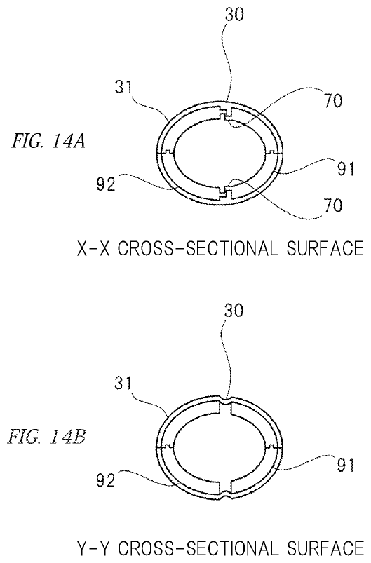

The present invention is not limited to the foregoing embodiments, and various modifications can be made within the scope of the outline of the present invention. For example, the first member and the second member that are connected to each other through the elastic body to be relatively movable are not limited to the main-body housing 10 and the handle housing 20 explained above. In embodiments shown in FIGS. 13 and 14A through 14B, a first member 91 and a second member 92 forming at least a part of the outer shell of the electric working machine are connected to each other through the elastic body 30 and the connecting portion 70 to be relatively movable. As similar to the elastic body 30 in each embodiment explained above, the elastic body 30 shown in FIGS. 13 and 14A through 14B is formed on the first member 91 and the second member 92 by the double-layer molding, and is a part of a continuous resin cover 31 covering surfaces of the first member 91 and the second member 92. And, each connecting portion 70 shown in FIGS. 13 and 14A through 14B substantially has the same structure as that of the connecting portion 70 shown in FIGS. 11 and 12A through 12C.

Meanwhile, in the embodiments shown in FIGS. 13 and 14A through 14B, the handle 21 is made of both the first member 91 and the second member 92. Specifically, as shown in FIG. 13, a front portion 21a of the handle 21 is made of the first member 91, and a back portion 21b of the handle 21 is made of the second member 92.

An intermediate portion 73 of each connecting portion 70 (see FIGS. 12A through 12C for the “intermediate portion 73”) is broken by application of a predetermined force (F1) or more to the second member 92 shown in FIG. 13, the force acting in a direction of bringing the second member 92 to be close to the first member 91, or by application of a predetermined force (F2) or more thereto, the force acting in a direction of bringing the second member 92 to be away from the first member 91. In other words, a plurality of connecting portions 70 shown in FIGS. 13 and 14A through 14B are broken.

After the connecting portion 70 is broken, the first member 91 and the second member 92 are connected to each other through only the elastic body 30. In other words, the first member 91 and the second member 92 are connected to each other to be relatively movable. In still other words, the back portion 21b of the handle 21 is mainly movable frontward and backward relative to the first member 91 including the front portion 21a of the handle 21. As a result, the vibration occurring in the first member 91 is prevented or suppressed from propagating to the back portion 21b of the handle 21. Note that the back portion 21b of the handle 21 is a portion mainly in contact with a palm of the operator who is gripping the handle 21.

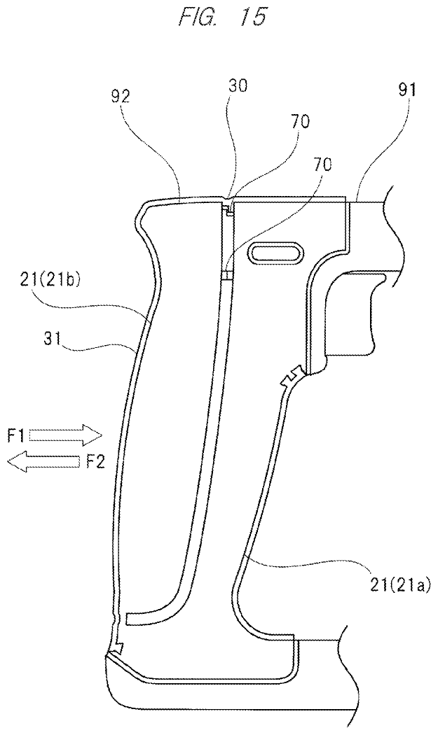

As shown in FIG. 15, only an upper portion of the second member 92 may be connected to the first member 91 through one or two connecting portions 70 or more. In this case, after the connecting portion(s) 70 is broken, the second member 92 shown in FIG. 15 is movable (swingable) relative to the first member 91 to take its lower portion as a fulcrum.

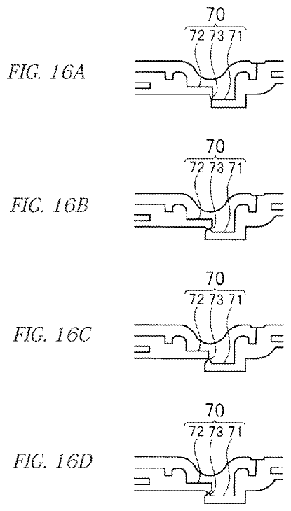

The shape of the connecting portion according to the present invention is not limited to the shapes illustrated in the above-referenced drawings. The connecting portion according to the present invention only needs to include the first end connected to the first member, the second end connected to the second member, and the intermediate portion that connects the first end and the second end and that is weaker than the first end and the second end, and the shape of the connecting portion is not particularly limited. Accordingly, FIGS. 16A through 16D show some of modification examples of the connecting portion.

The connecting portion 70 shown in FIGS. 16A through 16D includes a first end 71, a second end 72 and an intermediate portion 73. The intermediate portion 73 connecting the first end 71 and the second end 72 is thinner than the first end 71 and the second end 72 or has at least a part that is thinner than the first end 71 and the second end 72, and is weaker than the first end 71 and the second end 72 as a whole.

The connecting portion 70 shown in FIG. 16A includes an intermediate portion 73 that is gradually thinned from the second end 72 toward the first end 71, and an apex of the intermediate portion 73 is connected to the first end 71. The connecting portion 70 shown in FIG. 16B includes an intermediate portion 73 having an arc portion that gradually expands from the second end 72 toward the first end 71 and an arc portion that gradually expands from the first end 71 toward the second end 72, and apexes of the two arc portions are connected to each other. The connecting portion 70 shown in FIG. 16C includes an intermediate portion 73 that is gradually thinned from the first end 71 toward the second end 72, and an apex of the intermediate portion 73 is connected to the second end 72. The connecting portion 70 shown in FIG. 16D includes an intermediate portion 73 having a sharp portion that is gradually thinned from the second end 72 toward the first end 71 and a sharp portion that is gradually thinned from the first end 71 toward the second end 72, and apexes of the two sharp portions are connected to each other.

### EXPLANATION OF REFERENCE CHARACTERS

1A, 1B and 1E . . . hammer drill, 1C . . . saber saw, 1D . . . round saw, 2 . . . outer shell, 3 . . . drill bit (saw blade), 10 . . . main-body housing, 10a and 20a . . . end surface, 10b and 20b . . . slit, 11 . . . upper joint, 12 . . . lower joint, 13 . . . engaging portion, 14 . . . joint pin, 20 . . . handle housing, 21 . . . handle, 21a . . . front portion, 21b . . . back portion, 22 . . . trigger lever, 23 . . . battery attachment portion, 24 . . . battery pack, 25 . . . upper end, 26 . . . lower end, 27 . . . engaging portion, 28 . . . joint pin, 30 . . . elastic body, 31 . . . resin cover, 32 . . . upper end, 32a . . . intervening portion, 32b . . . handle-housing side engaging portion, 32c . . . main-body-housing side engaging portion, 33 . . . lower end, 40 . . . motor, 41 . . . transmission mechanism, 42 . . . cooling fan, 43 . . . pinion gear, 44 . . . bevel gear, 45 . . . intermediate shaft, 46 . . . cylinder, 47 . . . retainer sleeve, 50 and 51 . . . mold, 60a and 60b . . . limitation member, 61, 62 and 67 . . . metallic plate, 63 and 64 . . . bent portion, 65 and 66 . . . large radial portion, 68 . . . long hole, 70 . . . connecting portion, 71 . . . first end, 72 . . . second end, 73 . . . intermediate portion, 91 . . . first member, 92 . . . second member

1-11. (canceled)

12. An electric working machine which includes a motor serving as a driving source and which can be equipped with a tip tool driven by a driving force that is output from the motor, comprising:
a first portion and a second portion forming at least a part of an outer shell,
wherein the first portion and the second portion are positioned to separate from each other and relatively movable, and
an elastic body formed on the outer shell by a double-layer molding is arranged to straddle the first portion and the second portion.

13. The electric working machine according to claim 12,
wherein the first portion is a part of a main-body housing configured to house the motor and a transmission mechanism transmitting the driving force, that is output from the motor, to the tip tool, and
the second portion is a part of a handle gripped by an operator.

14. The electric working machine according to claim 13,
wherein the handle includes a battery attachment portion to which a battery for supplying a power to the motor is attached.

15. The electric working machine according to claim 12,
wherein the elastic body is formed on both the first portion and the second portion by a double-layer molding.

16. The electric working machine according to claim 12,
wherein
a first engaging portion engaging with the elastic body is formed on a surface of an end of the first portion, the end being closer to the second portion, and
a second engaging portion engaging with the elastic body is formed on a surface of an end of the second portion, the end being closer to the first portion.

17. The electric working machine according to claim 13,
wherein a handle housing forming the handle includes an upper end and a lower end connected to the main-body housing.

18. The electric working machine according to claim 12, further comprising
a limitation member intervening between the first portion and the second portion and limiting a motion amount of the second portion relative to the first portion into a predetermined range.

19. The electric working machine according to claim 12,
wherein the first portion and the second portion are a single member, and
the first portion and the second portion are relatively movable due to deformation of the member.

20. The electric working machine according to claim 17,
wherein a wiring penetrating in the handle housing and the main-body housing is included, and
the wiring is covered with the elastic body.

21. The electric working machine according to claim 17,
wherein the tip tool is struck due to pressure change caused by reciprocation of a piston in forward and backward directions, and
the second portion is movable relative to the first portion in the forward and backward directions.

22. An electric working machine which includes a motor serving as a driving source and which can be equipped with a tip tool driven by a driving force that is output from the motor, comprising:
a first portion and a second portion forming at least a part of an outer shell,
wherein the first portion and the second portion are connected to each other through a connecting portion and an elastic body,
the connecting portion has a first end continuously connected to the first portion, a second end continuously connected to the second portion, and an intermediate portion connecting the first end and the second end,
the first end, the second end and the intermediate portion are monolithically formed, and the intermediate portion is weaker than the first end and the second end, and
the elastic body is formed on the first portion and the second portion by a double-layer molding, and is a part of a continuous resin cover straddling the connecting portion and covering surfaces of the first portion and the second portion.

23. The electric working machine according to claim 22,
wherein the intermediate portion is broken by application of a predetermined force or more to the second portion, the force acting in a direction of bringing the second portion to be close to the first portion or bringing the second portion to be away from the first portion.

24. The electric working machine according to claim 22,
wherein a thickness of the intermediate portion is smaller than each thickness of the first end and the second end.

25. The electric working machine according to claim 22,
wherein the second portion forms a part of a handle gripped by an operator.

26. The electric working machine according to claim 12,
wherein a material of the elastic body is elastomer.

27. The electric working machine according to claim 12,
wherein the first portion is made of combination of one-side first portion and other-side first portion that are splitable in a predetermined direction,
the second portion is made of combination of one-side second portion and other-side second portion that are splitable in a predetermined direction, and
the elastic body includes a one-side elastic body formed on the one-side first portion and the one-side second portion by a double-layer molding and an other-side elastic body formed on the other-side first portion and the other-side second portion by a double-layer molding.
